(19) United States
(12) Patent Application Publication
(10) Pub. No.: US 2006/0061807 A1
(43) Pub. Date: Mar. 23, 2006

(54) Printing control apparatus, program, printing system, and controlling method for printing system

(75) Inventor: Takao Matsuda, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/210,801

(22) Filed: Aug. 25, 2005

(30) Foreign Application Priority Data
Sep. 21, 2004 (JP) 2004-273602

(51) Int. Cl. G06F 3/12

(52) U.S. Cl. 358/1.15

(57) ABSTRACT

The present invention is a printing control apparatus controlling a printing machine, in which the printing control apparatus causing the printing machine to sequentially print, for normal use, a plurality of sets of copies for a printing matter including a plurality of sheets as a set of copies, set by set; the printing control apparatus causing the printing machine to print a sheet for the printing matter for sample use in a page sequence of the printing matter, while a predetermined number of sets of copies for the printing matter printed for normal use is printed; the printing matter printed for normal use is ejected to an output tray of the printing machine; and the printing matter for sample use is ejected separately from the printing matter for normal use.

### BACKGROUND OF THE INVENTION

1. Field of the Invention

The present invention relates to a printing control apparatus, and more particularly, to a printing control apparatus causing a printing machine to perform a sample printing while printing.

2. Description of the Background Art

Conventionally, a sample printing has been performed for the purpose of checking a printing state while printing. In other words, in an event of printing a printing matter, a portion of a large amount of the printing matter is printed for use as a sample (for checking). Through checking the thereby outputted printing matter for sample use, a user (a printing operator) can check the printing state of the printing machine of the time when the printing matter was being outputted.

FIG. 7 is a diagram illustrating a conventional method for the sample printing. Note that, here, one set of copies for a printing matter includes a plurality of sheets (N sheets, in FIG. 7 (where N is a natural number equal to or more than two)). M sets of copies (where M is a natural number equal to or more than two) for the printing matter are sequentially outputted set by set. In other words, a first set of copies is obtained from sequentially outputting from the first page to the N-th page, and, next, a second set of copies is obtained in a similar manner to the first set of copies. A third set of copies and thereafter are also outputted in a similar manner to the first set of copies, and an output on a set of copies basis is repeated until the M-th set of copies.

In FIG. 7, the sample printing is performed at a constant interval so as to provide one collective set of copies for sample use for each constant interval. Specifically, the printing machine subsequently outputs one set of copies for the printing matter for sample use for each predetermined number of sets of copies printed by normal printing (namely, for each predetermined number of sets of copies of a printing matter outputted). In FIG. 7, an i-th set of copies (where i is a natural number between one and M) of the printing matter is outputted for sample use. Note that “to be outputted for sample use” means that a sample is ejected so as to be distinguished from a printing matter other than the sample. Specifically, the printing machine has at least two output trays, a printing matter for normal use (a printing matter other than a sample) is ejected to one output tray, and, on the other hand, a printing matter for sample use is ejected to another of the at least two output trays. Also, in order to distinguish the printing matter for normal use and that for sample use, an insert sheet may be inserted therebetween, or ejection positions thereof may be slightly displaced from each other. Mechanisms of the printing machine for separately outputting the printing matter for normal use from the printing matter for sample use are disclosed, for example, in Japanese Laid-Open Patent Publication No. 8-133555.

According to the conventional method, the time interval for the sample printing is a time interval for a predetermined number of sets of copies printed by the normal printing. Consequently, the time interval between the sample printing and a next sample printing is long, and thus the printing state between the sample printings cannot be grasped. Therefore, if the time interval between the sample printings is long as in the conventional method, it is impossible to check the changes in the printing state over time in detail.

### SUMMARY OF THE INVENTION

Therefore, an object of the present invention is to provide a printing control apparatus allowing a detailed check for changes in a printing state over time.

A first aspect of the present invention is directed to a printing control apparatus controlling a printing machine. The printing control apparatus includes normal printing control means, first sample printing control means, and ejection control means. The normal printing control means causes the printing machine to sequentially print a plurality of sets of copies for a printing matter including a plurality of sheets as a set of copies, set by set. The first sample printing control means causes the printing machine to print a sheet for the printing matter for sample use in a page sequence of the printing matter, while a predetermined number of sets of copies for the printing matter is printed under a control from the normal printing control means. The ejection control means causes the printing matter printed under the control from the normal printing control means to be ejected to an output tray of the printing machine, and the printing matter for sample use printed under a control from the first sample printing control means to be ejected separately from the printing matter printed under the control from the normal printing control means.

In a second aspect, in a case of printing a page for which a variable printing is to be performed, the first sample printing control means may cause the printing machine to print, for use as a sample, only a stationary section in which a printing content is constant in the variable printing.

In a third aspect, the first sample printing control means may cause the printing machine to print a page, to be printed, immediately after the page is printed under the control from the normal printing control means.

In a fourth aspect, the printing control apparatus may further include second sample printing control means. In a case where a last page printed under the control from the first sample printing control means is not the final page of the printing matter, the second sample printing control means causes the printing machine to print from a page following the last page printed under the control from the first sample printing control means to the final page of the printing matter. Here, the ejection control means causes the printing matter printed under a control from the second sample printing control means to be ejected.

Note that the above-described invention may be provided in a form of a program which a computer for the printing control apparatus executes. Through executing the program, functions of the aforementioned invention are realized with the printing control apparatus. Also, the aforementioned program may be provided in a form of an arbitrary computer-readable storage medium having the program stored therein. Also, the aforementioned invention may be provided in a form of a printing system including the above-described printing control apparatus and the printing machine, or as a printing method for use by the printing system.

According to the first aspect, one sheet for the printing matter for sample use is outputted while a predetermined number of sets of copies for a printing matter printed under the control from the normal printing control means is outputted. In other words, the printing matter for sample use is outputted not on a set of copies basis, but on a sheet basis. Accordingly, compared to the sample printing in the conventional method, in outputting an equal amount of a printing matter for sample use, the time interval between the sample printings can be shortened. Therefore, according to the first aspect, the sample printing can be performed in a shorter time interval, allowing more detailed check for the changes in the printing state over time.

Further, according to the first aspect, the printing matter for sample use is outputted in the page sequence. The page number of the printing matter for sample use thereby corresponds to a time sequence, and therefore, through checking the printing matter for sample use in the page sequence, a user can easily recognize the changes in the printing state over time.

Further, according to the second aspect, in a case where the sample printing is performed on a page for which the variable printing is to be performed, the content for the variable section unnecessary for printing is not printed, whereby the printing process is simplified, and, simultaneously, an intended purpose, i.e., to check the printing state, can be sufficiently achieved.

Further, according to the third aspect, the same page is successively printed for the normal printing followed by the sample printing. Timing for the sample printing in each set of copies printed by the normal printing varies according to the page number of the printing matter for sample use. Accordingly, through varying the timing for the sample printing in each set of copies printed by the normal printing, the user can check the printing state of various points in time. Furthermore, according to the third aspect, in the event of transmitting, from the printing control apparatus to the printing machine, data for a document having the page to be successively printed, it is possible to collectively transmit the data in one time.

Further, according to the fourth aspect, the printing matter for sample use can be outputted such that one complete set of copies is always provided.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a structure of a printing system according to a first embodiment;

FIG. 2 is a diagram used for explaining an outline of a printing process according to the first embodiment;

FIG. 3 is a flowchart illustrating a flow of the printing process executed by a server 2 according to the first embodiment;

FIGS. 4A, 4B, 4C, 4D, and 4E are diagrams illustrating pages for which a variable printing is performed;

FIG. 5 is a diagram illustrating an outline of a printing process according to a second embodiment;

FIG. 6 is a flowchart illustrating a flow of the printing process executed by a server 2 according to the second embodiment;

FIG. 7 is a diagram illustrating a conventional method for a sample printing.

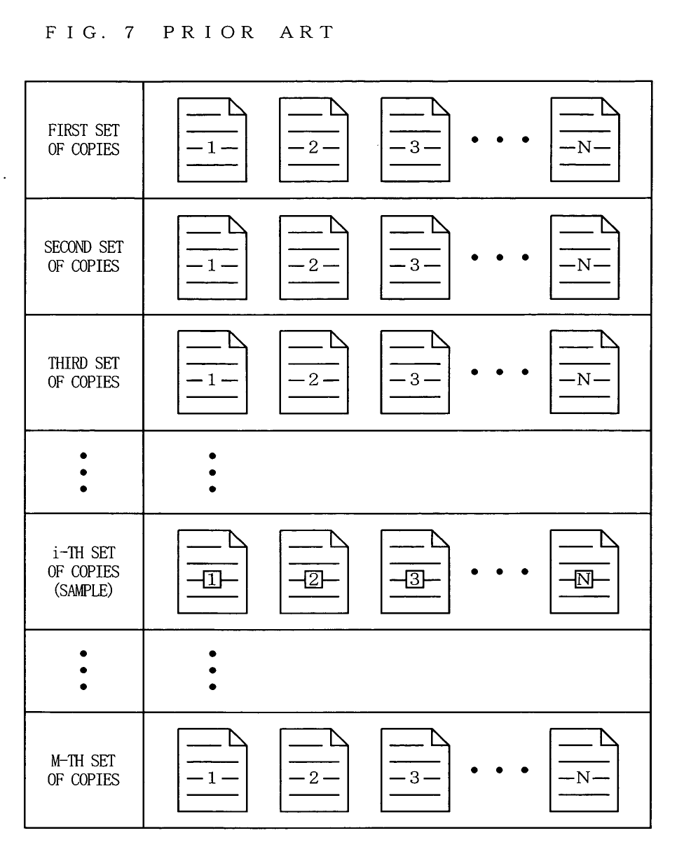

### DESCRIPTION OF THE PREFERRED EMBODIMENTS

### First Embodiment

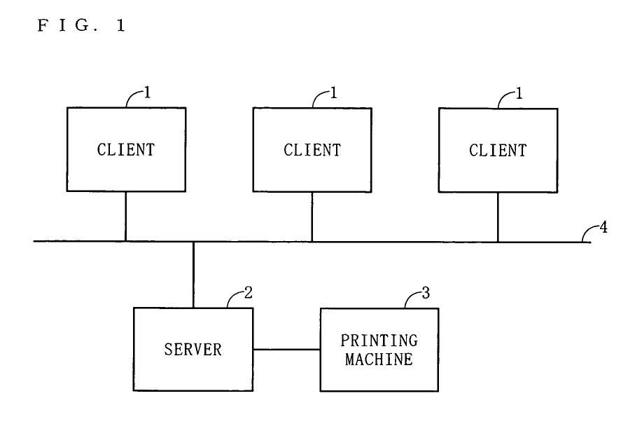

FIG. 1 is a diagram illustrating a structure of a printing system in a first embodiment. The printing system illustrated in FIG. 1 includes client apparatuses (hereinafter, simply referred to as “clients”) 1, a server apparatus (hereinafter, simply referred to as a “server”) 2, and a printing machine 3. A plurality of (three, in FIG. 1) clients 1 and the server 2 are connected to each other by a network 4 such as a LAN. Also, the server 2 is connected to the printing machine 3 which is a target for control.

The client 1 transmits a printing instruction to the server 2. The printing instruction includes information, such as a document to be printed and/or the number of copies to be printed, required by the printing machine 3 for printing. The document is created and edited by a user using the client 1. When printing the created document, the client 1 transmits the aforementioned printing instruction to the server 2, according to an instruction from the user. Note that, in FIG. 1, the printing system includes three clients 1, but the number of the clients 1 may vary.

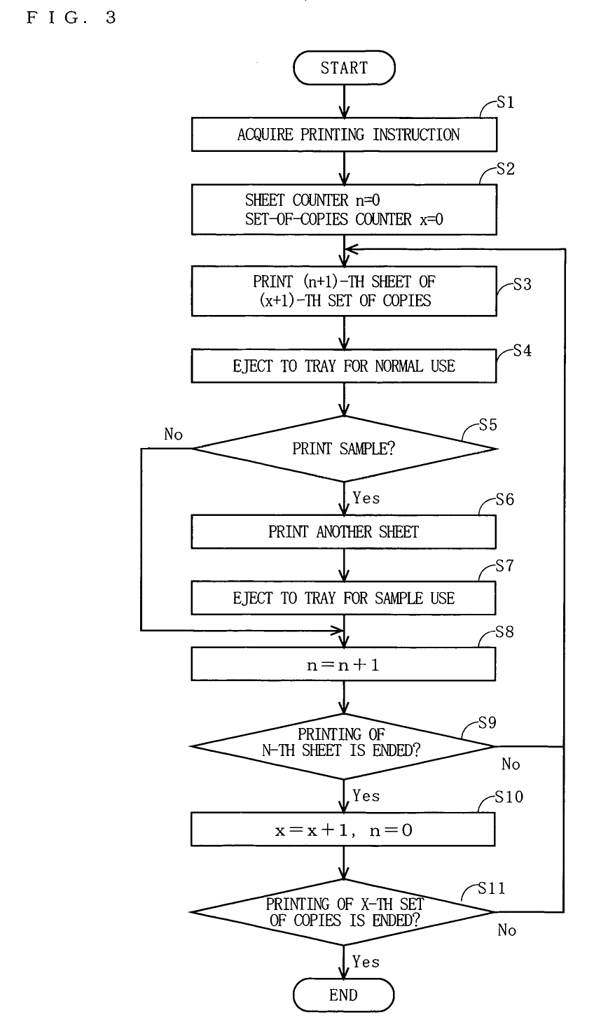

The server 2 controls the printing machine 3 in accordance with the printing instruction transmitted from the client 1. In other words, the server 2 controls an operation of the printing machine 3 such that the document indicated by the printing instruction is printed in the number of copies indicated by the printing instruction. Here, the server 2 has a function of performing a normal printing and a function of performing a sample printing. The sample printing is a printing in which a printing matter for sample use is outputted for the purpose of checking the printing state of the printing machine 3. The normal printing is a printing other than the sample printing. Specifically, in the normal printing, the server 2 causes the printing machine 3 to sequentially print a plurality of sets of copies for a printing matter including a plurality of sheets as a set of copies, set by set (step S3, in later described FIG. 3). On the other hand, in the sample printing, the server 2 causes the printing machine 3 to print a sheet for the printing matter for sample use, in a page sequence, while printing one set of copies for the printing matter obtained from the normal printing (step S6, in later described FIG. 3). The printing machine 3 includes at least two output trays, and the server 2 has a function for selecting an output tray to which the printing matter is to be ejected (steps S4 and S7, in later described FIG. 3).

The server 2 is typically a personal computer, and the above described functions (the function for performing the normal printing, the function for performing the sample printing, and the function for selecting an output tray) are realized by a CPU of the personal computer executing a predetermined program. A process performed by the CPU of the server 2 executing the predetermined program is illustrated in later described FIG. 3.

The printing machine 3 performs the printing in accordance with the instruction from the server 2. In other words, the printing matter is outputted to an output tray as a printed document indicated by the printing instruction. Also, the printing machine 3 can change, through the instruction from the server 2, which output tray to eject the printing matter. In other words, the server 2 controls the printing machine 3 such that the printing matter outputted from the normal printing and the printing matter outputted from the sample printing are ejected to a different output tray from each other. Note that, hereinafter, the output tray to which the printing matter having been printed by the normal printing is ejected is referred to as a “tray for normal use”, and the output tray to which the printing matter having been printed by the sample printing is ejected is referred to as a “tray for sample use”.

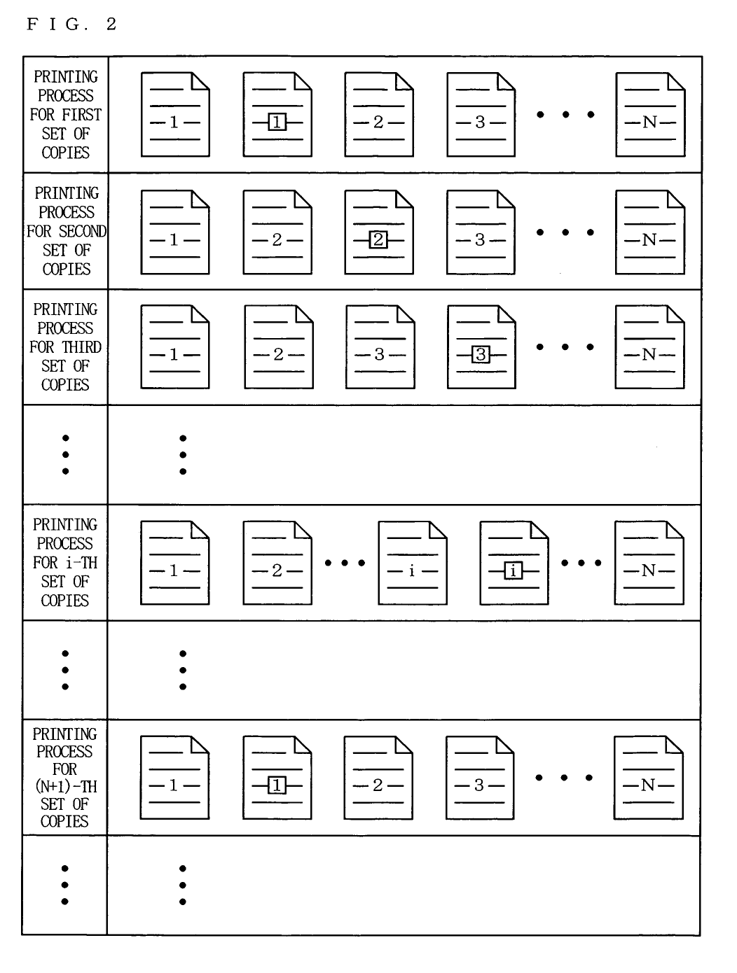

FIG. 2 is a diagram used for explaining an outline of a printing process in the first embodiment. Here, described is an exemplary case where a document including N pages (where N is a natural number equal to or more than two) is printed on one side of a printing medium, namely, a case where a printing matter including N sheets as a set of copies is printed. Also, here, described is an exemplary case where X sets of copies (where X is a natural number equal to or more than N) for the printing matter are outputted. Note that, in FIG. 2, the number shown inside of a figure schematically illustrating one sheet for a printing matter indicates a sheet number (a page number) of the document. Also, the number enclosed in a square indicates a printing matter for sample use.

When the printing instruction is received from the client 1, the server 2 firstly performs a printing process for a first set of copies. In the printing process for the first set of copies, one set of copies for the printing matter from the first to the N-th sheet obtained from the normal printing is outputted, together with one sheet from the sample printing for the first sheet of the printing matter. Note that “a j-th sheet (where j is an arbitrary natural number) of a printing matter” means a j-th page of the printing matter including N sheets, and does not mean a j-th sheet of the total number of sheets printed. For example, when printing a printing matter including N sheets set by set in the page sequence, the first page of the second set of copies of the printing matter is a “first page” and not an “(N+1)-th page”.

In a first printing process, the first page of the printing matter is firstly outputted. The printing matter is ejected to the tray for normal use. Next, the same first page of the printing matter is outputted for sample use. Namely, in printing of the first set of copies, two sheets for the first sheet of the printing matter are outputted. The first sheet of the printing matter for sample use is ejected to the tray for sample use. Subsequently, the normal printing is performed from the second to the N-th sheet. In other words, the printing matter is sequentially outputted from the second to the N-th sheet, and sequentially ejected to the tray for normal use.

After the printing process for the first set of copies is ended, the server 2 performs the printing process for a second set of copies. In the printing process for the second set of copies, one set of copies for the printing matter from the first to the N-th sheet obtained from the normal printing is outputted, together with one sheet from the sample printing for the second sheet of the printing matter. Specifically, at first, the first and the second sheets of the printing matter are sequentially outputted, and ejected to the tray for normal use. Next, the second sheet of the printing matter is outputted for sample use, and ejected to the tray for sample use. Subsequently, for the third to the N-th sheet of the document, the normal printing is performed. In other words, the printing matter from the third to the N-th sheet is outputted in the sheet sequence, and sequentially ejected to the tray for normal use.

After the printing process for the second set of copies is ended, the server 2 performs the printing process for a third set of copies and thereafter. In the printing process for the third set of copies and thereafter, the process is also performed in a similar manner to the process for the first and the second set of copies. In other words, in the printing process for an arbitrary i-th set of copies (where i is a natural number between one and N), one set of copies for the printing matter from the first to the N-th sheet is outputted, together with one sheet for the i-th sheet of the printing matter for sample use. Through performing the printing process from the first to the N-th set of copies, the server 2 performs the sample printing for each sheet in the document from the first to the N-th page. Accordingly, one set of copies for the printing matter outputted for sample use is provided by performing the printing process from the first to the N-th set of copies.

Subsequent to the printing process for the N-th set of copies, the printing process for an (N+1)-th set of copies is performed. In the printing process for the (N+1)-th set of copies and thereafter, the server 2 repeats a process similar to the printing process from the first to the N-th set of copies. In other words, in the printing process for the (N+1)-th set of copies, the server 2 performs a process similar to the printing process for the first set of copies (refer to FIG. 3), and, in the printing process for the (N+2)-th set of copies, a process similar to the printing process for the second set of copies is performed. Hereafter, the server 2 repeats a process similar to the printing process from the first to the N-th set of copies until the printing process for the X-th set of copies is performed.

Note that, in the above-description for FIG. 2, a case where the printing is performed on one side of a printing medium is described, but the same process can also be applied to a case where the printing is performed on both sides of the printing medium. For example, when considering a case where X sets of copies of a document including 2N pages is printed on both sides of a printing medium, in the printing process for an arbitrary i-th set of copies, one set of copies for the printing matter from the first (corresponding to the first and the second page) to the N-th sheet (corresponding to the (2N−1)-th and the 2N-th page) is outputted, together with the printing matter for the i-th sheet (corresponding to the (2i−1)-th and the 2i-th page) for sample use.

As such, in the first embodiment, while one set of copies for the printing matter for normal use is outputted, one sheet for the printing matter for sample use is outputted. Here, considered is a case where, as in the present embodiment, one set of copies for the printing matter for sample use is outputted when N sets of copies for the printing matter for normal use is outputted. In such a case, in a conventional method, the sample printing is performed with respect to each N sets of copies for the printing matter for normal use outputted, whereas, in the first embodiment, the sample printing is performed with respect to each one set of copies for the printing matter for normal use outputted. In other words, conventionally, the sample printing has been performed at intervals of N sets of copies, whereas, in the first embodiment, the sample printing is performed at intervals of one set of copies. Therefore, according to the first embodiment, the sample printing can be performed in a shorter time interval relative to the conventional method, and thus making it possible to observe changes in a printing state over time in detail.

Next, the printing process according to the first embodiment is described in detail. FIG. 3 is a flowchart illustrating a flow of the printing process executed by the server 2 in the first embodiment. The process illustrated in FIG. 3 is a process executed by a CPU of the server 2 executing a predetermined program.

In step S1, the server 2 acquires a printing instruction. Specifically, the server 2 acquires information for the printing instruction (a printing job) from one of the clients 1. Here, it is assumed that the printing instruction includes data indicating a document to be printed, the number of sheets (the number of sheets to be printed) per one set of copies of the document, and the number of copies to be printed (the number of sets of copies to be printed) for the document. The values for the number of sheets to be printed N and the number of sets of copies to be printed X obtained in step S are stored in the server 2.

In subsequent step S2, the server 2 performs an initialization process for a counter. In the first embodiment, two counters such as a sheet counter n and a set-of-copies counter x are used. The sheet counter n is a counter indicating, in one set of copies of a printing matter, a sheet number corresponding to a sheet for the printing matter currently having been printed. The set-of-copies counter x is a counter indicating the number of sets of copies for the printing matter currently having been printed. As the initialization process, the server 2 sets the values for the sheet counter n and the set-of-copies counter x to zero.

In step S3, the server 2 causes the printing machine 3 to print the (n+1)-th sheet of the document. Specifically, the server 2 transmits, to the printing machine 3, an instruction for printing the (n+1) -th sheet of the document. The printing machine 3 executes the printing in accordance with the instruction. Note that a specific value for the (n+1)-th sheet is determined in accordance with the above-described sheet counter n. Also, the printing matter printed in step S3 is the (n+1)-th sheet of an (x+1)-th set of copies. In subsequent step S4, the server 2 causes the printing matter printed in immediately preceding step S3 to be ejected to the tray for normal use. Specifically, the server 2 transmits, to the printing machine 3, the instruction for ejecting, to the tray for normal use, the printing matter printed in immediately preceding step S3. The printing machine 3 determines which tray to eject the printing matter in accordance with the instruction, and ejects, to the tray for normal use, the printing matter printed in immediately preceding step S3. Note that the server 2 may collectively transmit, to the printing machine 3, the instructions for steps S3 and S4 at a time.

In step S5, the server 2 determines whether to print the printing matter for sample use. The determination in step S5 is carried out based on the values for the number of sheets to be printed N, the number of sets of copies to be printed X, and the sheet counter n. Specifically, the determination in step S5 is carried out based on whether a remainder obtained by dividing the number of sets of copies to be printed X by the number of sheets to be printed N is equal to the sheet counter n. In other words, if the remainder is equal to n, the server 2 determines that the printing matter for sample use is to be printed. Conversely, if the remainder is not equal to n, the server 2 determines that the printing matter for sample use is not to be printed. If, as a result of the determination in step S5, it is determined that the printing matter for sample use is to be printed, steps S6 and S7 are performed. On the other hand, if it is determined that the printing matter for sample use is not to be printed, steps S6 and S7 are skipped, and step S8 is performed.

In step S6, the server 2 causes another (n+1)-th sheet of the document printed in step S3 to be printed. Step S6 is similar to step S3. In subsequent step S7, the server 2 causes the printing matter printed in immediately preceding step S6 to be ejected to the tray for sample use. Specifically, the server 2 transmits, to the printing machine 3, an instruction for ejecting, to the tray for sample use, the printing matter printed in immediately preceding step S6, and the printing machine 3 determines which tray to eject the printing matter in accordance with the instruction, and ejects, to the tray for sample use, the printing matter printed in immediately preceding step S6. Note that the server 2 may collectively transmit, to the printing machine 3, the instructions for steps S6 and S7 at a time. Subsequent to step S7, step S8 is performed.

In step S8, the server 2 increases the value for the sheet counter n by one because, through performing immediately preceding step S3, the printing of the (n+1)-th sheet of the printing matter is finished. In subsequent step S9, the server 2 determines whether the N-th sheet of the printing matter is printed in immediately preceding step S3. The determination in step S9 is carried out based on whether the value for the number of sheets to be printed N and the current value for the sheet counter n are equal. In other words, when N=n, the server 2 determines that the N-th sheet of the printing matter has been printed in immediately preceding step S3. On the other hand, when N>n (according to the algorithm in FIG. 3, it is impossible to have N<n), the server 2 determines that the N-th sheet of the printing matter has not been printed in immediately preceding step S3. When it is determined that the N-th sheet of the printing matter has been printed in immediately preceding step S3 based on the determination in step S9, step S10 is performed. On the other hand, when it is determined that the N-th sheet of the printing matter has not been printed in immediately preceding step S3, the process returns to step S3, and steps S3 to S9 are again performed. In other words, steps S3 to S9 are repeated until one set of copies for the printing matter is printed, namely, until N=n.

Through the loop for above-described steps S3 to S9 in which step S3 is performed until n=0 becomes n=N, the normal printing from the first sheet to the n-th sheet, namely, the normal printing of one set of copies is performed. Also, in the loop for steps S3 to S9, step S6 is executed once. Accordingly, the sample printing of one sheet is performed.

In step S10, the server 2 updates the values for the counters. Specifically, the server 2 increases the value for the set-of-copies counter x by one, and resets the value for the sheet counter n to zero, because the printing of the (x+1)-th set of copies has been finished with the end of the printing of the (n+1)-th sheet of the printing matter in immediately preceding step S3. In subsequent step S11, the server 2 determines whether the X-th set of copies has been finished. The determination in step S11 is carried out based on whether the value for the number of sets of copies to be printed X and the current value for the set-of-copies counter x are equal. In other words, when X=x, the server 2 determines that the printing of the X-th set of copies has been finished. On the other hand, when X>x (according to the algorithm in FIG. 3, it is impossible to have X<x), the server 2 determines that the printing of the X-th set of copies has not been finished. When it is determined that the printing of the X-th set of copies has not been finished based on the determination in step S11, the process returns to step S3, and steps S3 to S11 are again performed. In other words, steps S3 to S11 are repeated until printing of all the printing matter to be printed is finished, namely, until X=x. On the other hand, when it is determined that the printing of the X-th set of copies is finished in immediately preceding step S3 based on the determination in step S11, the server 2 ends the process illustrated in FIG. 3.

In the above-described loop for steps S3 to S11, the loop for steps S3 to S9 is repeated X times. In other words, the normal printing of one set of copies is repeated X times so that X sets of copies for the printing matter obtained from the normal printing can be sequentially printed, set by set. Here, the detailed description for the process illustrated in FIG. 3 is ended.

As such, according to the first embodiment, the sample printing is performed for each one set of copies printed by the normal printing, and thus making it possible to check the printing state for each one set of copies outputted. Accordingly, the sample printing can be performed more frequently than in the conventional method, and therefore, changes in the printing state over time can be checked in more detail than in the conventional method. Further, according to the first embodiment, one sample printing provides one sheet for the printing matter. In other words, the output from a sample printing is by the sheet and not by one set of copies as in the conventional method. Consequently, the large amount of the printing matter for sample use is not wastefully outputted. According to the first embodiment, the sample printing can thereby be performed more frequently than in the conventional method, while the number of samples outputted is reduced.

Further, according to the first embodiment, the printing matter for sample use is outputted in the page sequence (in the sheet sequence). Therefore, the page number of the printing matter for sample use increases with time. In other words, the page number of the printing matter for sample use outputted in the first embodiment indicates the time sequence. Accordingly, through checking the printing matter for sample use in the page sequence, a user can easily recognize the changes in the printing state over time. For example, considered is a case where one hundred sets of copies of a document including fifty sheets as a set of copies are printed. In such a case, two sets of copies for the printing matter for sample use are outputted. If, for example, the printing state at forty-fifth sheet and thereafter of the printing matter for sample use is degraded, the user can easily recognize that, for the printing matter obtained from the normal printing, the printing state in forty-fifth set of copies and thereafter is degraded.

### Second Embodiment

Next, a printing system according to a second embodiment of the present invention is described. In the second embodiment, a variable printing in the printing system is considered. The variable printing is a printing method in which, when outputting a plurality sets of copies for a printing matter, a portion that is variable for its content for each section is included in the printing matter. The structure of the printing system in the second embodiment is similar to that in FIG. 1, and therefore, the description thereof is omitted in the second embodiment.

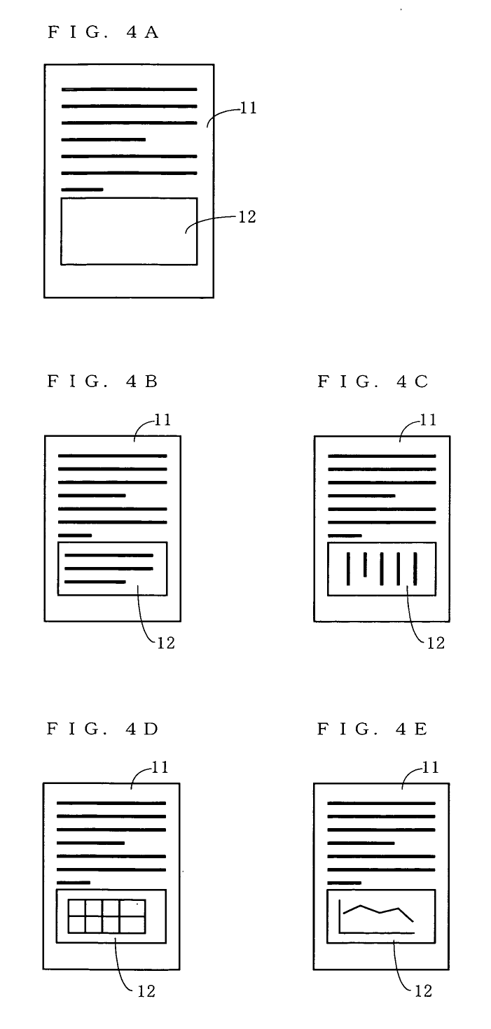

FIGS. 4A, 4B, 4C, 4D, and 4E are diagrams illustrating pages where the variable printing is performed. A document for which the variable printing is performed is divided into a stationary section 11 and a variable section 12. The stationary section 11 is a portion where a printing content is constant in the variable printing. In other words, the stationary section 11 is a portion where a same content is printed even in a case of printing a plurality of sets of copies. On the other hand, the variable section 12 is a portion where a different content is printed in the case of printing a plurality of sets of copies. FIGS. 4B to 4E are diagrams exemplary illustrating four different types of contents being printed in the variable section 12. As illustrated in FIGS. 4B to 4E, in the variable section 12, a different content is printed for each set of copies (or for each plural number of sets of copies). Note that, for the content for the variable section 12, an entirely different content may be printed for each set of copies, or plural types of contents may be selectively used for printing.

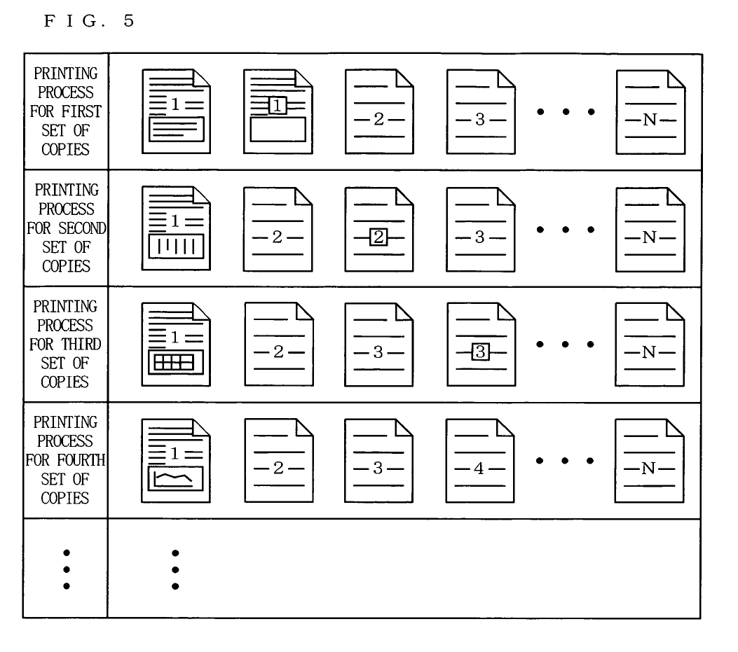

FIG. 5 is a diagram illustrating an outline of a printing process in the second embodiment. Here, described is an exemplary case where the variable printing is performed for a first sheet of a document including a plurality of sheets. Similar to the first embodiment, in the second embodiment, a server 2 prints two sheets for the first sheet of the document in printing of a first set of copies. In other words, after outputting the first sheet as a printing matter for normal use, the server 2 again outputs the first sheet as the printing matter for sample use. In the first embodiment, the contents for the printing matter for normal use and that for sample use are identical. However, in the second embodiment, the contents are different between the printing matter for normal use and that for sample use. Specifically, in the printing matter for normal use, a predetermined content is printed in both the stationary section and the variable section. On the other hand, in the printing matter for sample use, a content is printed only in the stationary section, and nothing is printed in the variable section. Note that, in an instance of outputting the printing matter for sample use, the process concerning a page where the variable printing is not performed is the same as that in the first embodiment.

As such, in the second embodiment, when performing the sample printing for a page where the variable printing is performed, the server 2 does not print a content for the variable section. The reason is that the printing matter for sample use is printed for the purpose of checking the printing state, and therefore, printing only the stationary section is enough to achieve the purpose. Also, in the case of performing the variable printing, more processes are required compared to the case where the variable printing is not performed. Required are, for example, a process for selecting a content for the variable section, a process for rasterizing data for the variable section in addition to data for the stationary section, a process for combining the data for the stationary section and the data for the variable section, and the like. Even in the sample printing, if a content for the variable section is to be printed, the server 2 has to execute these processes. However, when performing the sample printing in the second embodiment, no content is printed for the variable section, and therefore, the aforementioned processes become unnecessary, and can be omitted. In other words, in the second embodiment, an intended purpose, i.e., to check the printing state, can be sufficiently achieved while skipping unnecessary processes.

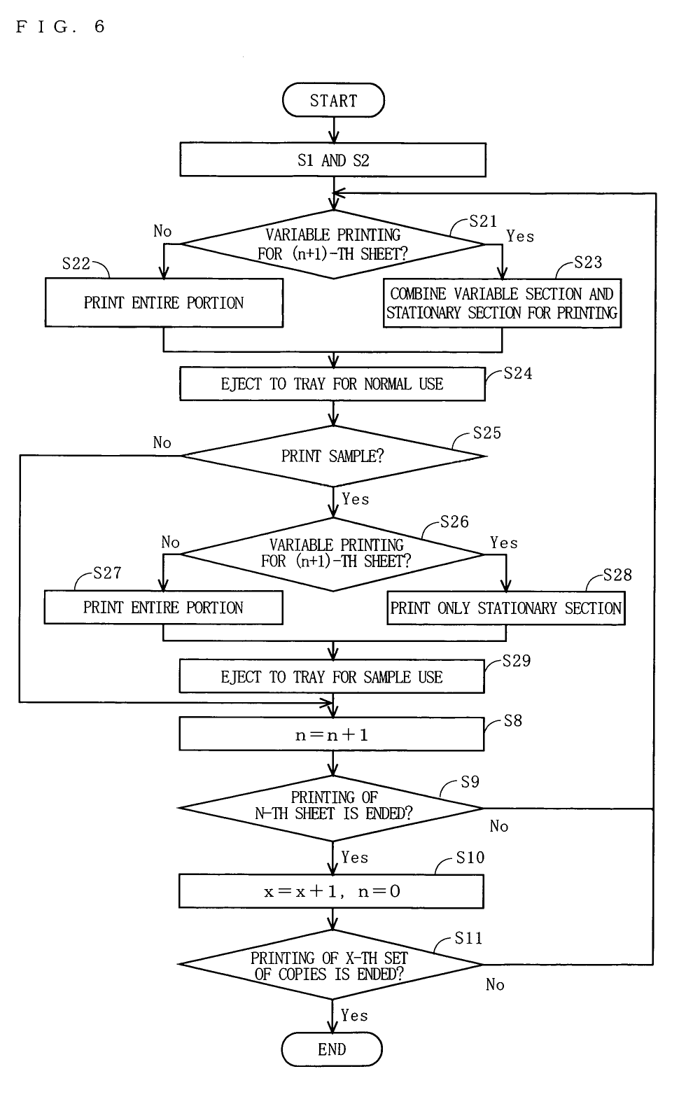

Next, a printing process of the second embodiment is described in detail. FIG. 6 is a flowchart illustrating a flow of the printing process executed by the server 2 in the second embodiment. Similar to the first embodiment, in the second embodiment, the server 2 performs the same process as in steps S1 and S2 illustrated in FIG. 3. In subsequent step S21, the server 2 determines whether the (n+1)-th page of the document is a page for which the variable printing is performed. It is assumed that information specifying, from among the pages of the document, the page for which the variable printing is performed is previously determined, and included in the printing instruction from a client 1. A specific value for the “(n+1)-th sheet” is determined in accordance with a sheet counter n.

In the determination made in step S21, when it is determined that the (n+1)-th sheet of the document is not a page for which the variable printing is to be performed, step S22 is performed. In step S22, the server 2 causes a printing machine 3 to print an entire portion of the corresponding page. Step S22 is similar to step S3 in the first embodiment. On the other hand, in step S21, when it is determined that the (n+1)-th sheet of the document is a page for which the variable printing is to be performed, step S23 is performed. Instep S23, the server 2 combines contents for the stationary section with that for the variable section, and causes the printing machine 3 to print the combined contents. After step S22 or S23, step S24 is performed. In step S24, the server 2 causes the printing matter printed in immediately preceding step S22 or S23 to be ejected to a tray for normal use. Step S24 is similar to step S4 in the first embodiment.

In step S25 subsequent to step S24, the server 2 determines whether a printing matter for sample use is printed. Step S25 is similar to step S5 in the first embodiment. When, as a result of the determination in step S25, it is determined that the printing matter for sample use is to be printed, steps S26 to S29 are performed. On the other hand, when it is determined that the printing matter for sample use is not to be printed, steps S26 to S29 are skipped, and step S8 is performed.

In step S26, the server 2 determines whether the (n+1)-th sheet of the document is a page for which the variable printing is performed. Step S26 is similar to step S21. In the determination made in step S26, when it is determined that the (n+1) -th sheet of the document is not the page for which the variable printing is to be performed, step S27 is performed. In step S27, the server 2 causes the printing machine 3 to print an entire portion of the corresponding page. Step S27 is similar to step S6 in the first embodiment. On the other hand, when, in step S26, it is determined that the (n+1)-th sheet of the document is the page for which the variable printing is to be performed, step S28 is performed. In step S28, the server 2 causes the printing machine 3 to print only the content for the stationary section. As such, in step S28, the printing matter for sample use having a blank variable section is printed.

After step S27 or S28, step S29 is performed. In step S29, the server 2 causes the printing matter printed in immediately preceding step S27 or S28 to be ejected to a tray for sample use. Step S29 is similar to step S7 in the first embodiment. Note that the process performed after step S29 is the same as that in the first embodiment, and therefore, the description thereof is omitted. Here, the detailed description for the process illustrated in FIG. 6 is ended.

In the first and the second embodiments, while one set of copies is printed by the normal printing, the sample printing of one sheet is performed. In another embodiment, the sample printing of one sheet may be performed while a plurality of sets of copies are printed by the normal printing. Specifically, in step S5 illustrated in FIG. 3, the determination may be made as to whether a remainder obtained by dividing the number of sets of copies to be printed X by the number of sheets to be printed N is equal to the sheet counter n, and a value for the set-of-copies counter x is a multiple of a predetermined natural number L (where L is an integer equal to or more than two). As such, the sample printing of one sheet can be performed with respect to each L sets of copies obtained from the normal printing. Through performing the sample printing of one sheet with respect to a plurality of sets of copies obtained from the normal printing as above, the amount of the printing matter for sample use can be reduced. Therefore, if the user desires a saving of printing medium, the above-described technique may be adopted. Further, the user may specify, from the client 1, the number of sets of copies for the normal printing associated with the sample printing of one sheet.

In the first and second embodiments, if the number of sets of copies to be printed X is indivisible by the number of sheets to be printed N, outputted for sample use is an incomplete set of copies of the printing matter. For example, if the number of sheets to be printed is fifty and the number of sets of copies to be printed is one-hundred twenty, the outputted printing matter for sample use are two complete sets of copies and a third set of copies from the first sheet to the twentieth sheet. As for the printing matter for sample use, it is not important to always have a complete set of copies, but, in another embodiment, a printing matter for sample use may be further outputted so that one complete set of copies is always provided. Specifically, the server 2 may perform a following process after the process illustrated in FIG. 3, for example. The server 2 determines whether the number of sets of copies to be printed X is divisible by the number of sheets to be printed N. Then, if it is indivisible, the printing machine 3 is caused to print the printing matter for sample use from a next page of the last page printed (the last page of the printing matter printed in step S6 illustrated in FIG. 3) to the final page of the printing matter. Further, the server 2 causes the printing matter having been printed to be ejected to a tray for sample use (ejecting for use as a sample, namely, ejecting in a similar manner to the printing matter for sample use). Accordingly, one complete set of copies of the printing matter for sample use is always outputted.

In the first and the second embodiments, the server 2 prints, for use as a sample, a page to be printed for sample use, immediately after the page is printed by the normal printing. For example, in printing of the first set of copies, the sample printing of the first page of the printing matter is performed immediately after the normal printing of the first page of the printing matter is performed. There are following advantages in printing a page for the printing matter for sample use immediately after printing the page by the normal printing, as above. The printing machine 3 prints the same page of the document two successive times, and therefore, there is no need to transmit, from the server 2 to the printing machine 3, the data for the document twice. Also, timing for the sample printing varies in each set of copies printed by the normal printing. For example, the first page of the printing matter for sample use is printed at about the beginning of when the first set of copies is printed by the normal printing, whereas the N-th page of the printing matter for sample use is printed at the end of when the N-th set of copies is printed by the normal printing (refer to FIG. 2). As such, timing for the sample printing in each one set of copies printed by the normal printing varies depending on a page order of the printing matter for sample use, whereby the printing state at various points in time can be checked.

In another embodiment, timing for printing the printing matter for sample use may vary if one sheet for the printing matter for sample use is printed with respect to each one set of copies (or a predetermined number of sets of copies) printed by the normal printing. Also, the sample printing matter may be ejected, by the printing machine 3, not to the tray for sample use, but to an output tray in a distinguishable manner from the printing matter for normal use. In other words, any methods may be taken as long as the sample printing matter is ejected separately from the normal printing matter. For example, even in a case where the normal printing matter and the sample printing matter are ejected to a same output tray, an insert sheet may be inserted therebetween, or ejection positions thereof may be slightly displaced from each other to distinguish between the two.

The present invention can be used as a printing control apparatus or the like in which the sample printing is performed by a printing machine during printing.

While the invention has been described in detail, the foregoing description is in all aspects illustrative and not restrictive. It is understood that numerous other modifications and variations can be devised without departing from the scope of the invention.

What is claimed is:

1. A printing control apparatus controlling a printing machine, comprising:
normal printing control means for causing the printing machine to sequentially print a plurality of sets of copies for a printing matter including a plurality of sheets as a set of copies, set by set;
first sample printing control means for causing the printing machine to print a sheet for the printing matter for sample use in a page sequence of the printing matter, while a predetermined number of sets of copies for the printing matter is printed under a control from the normal printing control means; and
ejection control means for causing the printing matter printed under the control from the normal printing control means to be ejected to an output tray of the printing machine, and the printing matter for sample use printed under a control from the first sample printing control means to be ejected separately from the printing matter printed under the control from the normal printing control means.

2. The printing control apparatus according to claim 1, wherein, in a case of printing a page for which a variable printing is to be performed, the first sample printing control means causes the printing machine to print, for use as a sample, only a stationary section which is a part where a printing content for the variable printing is constant.

3. The printing control apparatus according to claim 1, wherein the first sample printing control means causes the printing machine to print a page, to be printed, immediately after the page is printed under the control from the normal printing control means.

4. The printing control apparatus according to claim 1, further comprising:
second sample printing control means for causing, in a case where a last page printed under the control from the first sample printing control means is not a final page of the printing matter, the printing machine to print from a page following the last page printed under the control from the first sample printing control means to the final page of the printing matter, wherein
the ejection control means causes the printing matter printed under a control from the second sample printing control means to be ejected.

5. A printing control program to be executed by a computer for a printing control apparatus controlling a printing machine, the program causing the computer to function as:
normal printing control means for causing the printing machine to sequentially print a plurality of sets of copies for a printing matter including a plurality of sheets as a set of copies, set by set;
first sample printing control means for causing the printing machine to print a sheet for the printing matter for sample use in a page sequence of the printing matter, while a predetermined number of sets of copies for the printing matter is printed under a control from the normal printing control means; and
ejection control means for causing the printing matter printed under the control from the normal printing control means to be ejected to an output tray of the printing machine, and the printing matter for sample use printed under a control from the first sample printing control means to be ejected separately from the printing matter printed under the control from the normal printing control means.

6. The printing control program according to claim 5, wherein, in a case of printing a page for which a variable printing is to be performed, the first sample printing control means causes the printing machine to print, for use as a sample, only a stationary section which is a part where a printing content for the variable printing is constant.

7. The printing control program according to claim 5, wherein the first sample printing control means causes the printing machine to print a page, to be printed, immediately after the page is printed under the control from the normal printing control means.

8. The printing control program according to claim 5 causing, in a case where a last page printed under the control from the first sample printing control means is not a final page of the printing matter, the computer to further function as second sample printing control means by which the printing machine is caused to print from a page following the last page printed under the control from the first sample printing control means to the final page of the printing matter, wherein
the ejection control means causes the printing matter printed under a control from the second sample printing control means to be ejected.

9. A printing system comprising a printing machine and a printing control apparatus controlling the printing machine, wherein
the printing control apparatus comprises:
normal printing control means for causing the printing machine to sequentially print a plurality of sets of copies for a printing matter including a plurality of sheets as a set of copies, set by set; and
sample printing control means for causing the printing machine to print a sheet for the printing matter for sample use in a page sequence of the printing matter, while a predetermined number of sets of copies for the printing matter is printed under a control from the normal printing control means; wherein
the printing machine ejects the printing matter printed under the control from the normal printing control means to an output tray of the printing machine, and ejects the printing matter for sample use printed under a control from the sample printing control means separately from the printing matter printed under the control from the normal printing control means.

10. A printing method for use by a printing system, comprising a printing machine and a printing control apparatus controlling the printing machine, wherein
the printing control apparatus performs:
a normal printing control step causing the printing machine to sequentially print a plurality of sets of copies for a printing matter including a plurality of sheets as a set of copies, set by set; and
a sample printing control step causing the printing machine to print a sheet for the printing matter for sample use in the page sequence of the printing matter, while a predetermined number of sets of copies for the printing matter is printed in the normal printing control step, wherein
the printing machine ejects the printing matter printed in the normal printing control step to an output tray of the printing machine, and ejects the printing matter for sample use printed in the sample printing control step separately from the printing matter printed in the normal printing control step.
